(19) United States
(12) Patent Application Publication
(10) Pub. No.: US 2017/0150845 A1
(43) Pub. Date: Jun. 1, 2017

(54) COOKING VESSEL AND METHOD FOR MANUFACTURING A COOKING VESSEL

(71) Applicant: CRISTEL, Fesches le Chatel (FR)

(72) Inventors: Philippe Rossel, Vandoncourt (FR); Emmanuel Brugger, Dampierre les Bois (FR); Paul Dodane, Fesches le Chatel (FR)

(73) Assignee: CRISTEL, Fesches le Chatel (FR)

(21) Appl. No.: 15/322,196

(22) PCT Filed: Jul. 3, 2015
(86) PCT No.: PCT/FR2015/051846

§ 371 Date: Dec. 27, 2016

(30) Foreign Application Priority Data
Jul. 3, 2014 (FR) 1456354

(51) Int. Cl. A47J 36/02; B21D 51/22; B65D 81/38

(52) U.S. Cl. CPC A47J 36/02; B65D 81/38; B21D 51/22

(57) ABSTRACT

The present invention relates to a cooking vessel having a side wall connected to a base made up of at least three layers of material, namely, a top layer, a bottom layer, and an intermediate layer. The base includes an empty space that extends around the periphery of the base and is delimited between the bottom layer, the top layer, and the peripheral edge or a top peripheral annular face of the intermediate layer. The cooking vessel is characterized in that the vessel comprises a filling element adapted to fill the empty space.

### CROSS-REFERENCE TO RELATED APPLICATIONS

This application is a §371 filing of PCT application PCT/FR2015/051846 filed on Jul. 3, 2015, which claims priority from French application FR 1456354 filed on Jul. 3, 2014. The disclosures of these applications are included by reference herein in their entirety.

### BACKGROUND

The object of the present invention is a cooking vessel comprising a lateral wall connected to a base made up of at least three layers of material, namely a top layer, a bottom layer and an intermediate layer, said base comprising an empty space that extends around its periphery and that is delimited between the top layer, the bottom layer and the edge or a peripheral part of the intermediate layer.

It has been found that the presence of an empty space within the bottom of some cooking vessels presents a number of drawbacks. Thus, for example it can be observed that this empty space limits the efficiency of those cooking vessels thus considered, because it prevents the homogeneous distribution of heat between the different layers of material that constitute the bases thereof. Due to the presence of empty space, the base can also be subjected to heat energy accumulation phenomena, upon reduced surfaces, which can cause inadvertent discoloration of the material where there are areas of overheating.

Moreover, for some applications, it may be essential to have a cooking vessel wherein the base presents special properties, for example in allowing for a thermal break or a mechanical discontinuity between the different layers of materials that constitute said base.

We know for example from the document U.S. Pat. No. 4,204,607, of a cooking vessel with a lateral wall attached to a base consisting of at least three layers of material including a top layer, a bottom layer and an intermediate layer. Within this utensil, various spaces between the layers that constitute the bottom and especially around the peripheral edge of the intermediate layer, are filled with a mixture of materials. The latter contributes substantially to the adhesion of the different layers and is in no way intended to optimize the thermal properties therein. The thermal behavior of such an assembly cannot therefore be modified or adapted.

### BRIEF SUMMARY OF THE INVENTION

The purpose of the present invention is to propose a solution that will overcome the disadvantages associated with the poor distribution of the heat at the base of a cooking vessel or to provide a cooking vessel that presents special properties, notable the presence of a thermal break or mechanical discontinuity between the different layers of materials that constitute the base therein, such as that mentioned above.

For this purpose, the present invention relates to a cooking vessel with a lateral wall attached to a base consisting of at least three layers of material namely a top layer, a bottom layer and an intermediate layer, said base comprising an empty space that extends around its periphery and that is delimited between the bottom layer, the top layer and the edge or a peripheral face of the intermediate layer.

The cooking vessel is characterized in that it comprises a filling element that is able to fill the empty space. Thus, depending upon the nature of the material that constitutes the filling element and the shape of said filling element, special features regarding the base of the cooking vessel can be made available.

According to a characteristic of the invention, said filling element is at least partially made from a ductile material allowing, if necessary, for the easy deformation therein during the manufacture of the cooking vessel.

According to an embodiment, the filling element is at least partially made from a thermally conductive material, in order to ensure homogeneous heat distribution at the base of the cooking vessel. The thermally conductive material can be a metal selected from the group consisting of aluminum, copper, their alloys or any equivalent thermally conductive material.

According to another embodiment, the filling element is at least partially made from a thermally insulating material, allowing if necessary to ensure a thermal break between the layers of material that constitute the base of the cooking vessel. The thermally insulating material can be selected from the group consisting of silicon, zirconium or any equivalent thermally insulating material.

According to a characteristic of the invention, the filling element can present a volume that is substantially complementary to that of the empty space to be filled. For example, the filling element can initially present a toroidal shape.

The object of the invention is also a method for manufacturing a cooking vessel such as that defined previously, wherein at least three layers of material including a top layer, a bottom layer, and an intermediate layer overlap in order to form the base of the vessel, whilst at least the top layer is intended to also form the lateral wall of the vessel, and then the said vessel is made by forming, embossing or pressing said layers of materials. This method is characterized in that a step is provided wherein, by means of a filling element, an empty space is filled, said base including said space which extends around the periphery of said base between the lateral wall, the top layer, the bottom layer, and the edge or a peripheral face of the intermediate layer.

According to an alternative embodiment, when such layers of materials are overlapped, a filling element, in solid form, is arranged around the peripheral edge of the intermediate layer, between the top layer and the bottom layer.

According to another variant, the filling element is arranged on a top peripheral annular face of the intermediate layer.

In this case, a filling element is used, preferably of a shape that is substantially complementary to that of the empty space to be filled.

According to a further embodiment according to the invention, the manufacturing process consists of separately stamping the top layer and the bottom layer in order to form two chambers, fastening one of said chambers to the intermediate layer, which is made in the form of a disk and assembling said chambers by integrating, at least locally, an insulating layer between said chambers. The inner chamber is thus advantageously slotted or inserted into the outer chamber thus enclosing the intermediate layer and the filling element.

According to a further embodiment, the method according to the invention consists in using an intermediate layer in the form of a disc that is machined on its underside and in arranging and fastening the potentially preformed filling element on a top peripheral annular face of said intermediate layer.

According to a further embodiment, a filling element in liquid or powder form is injected into said empty space after the stamping, forming or embossing step.

The present invention also provides for the possibility of performing the empty space filling step at the same time as the stamping, embossing or forming step which is performed by immersing said layers of material in a bath of a filling element either in liquid form or in the form of microbeads or powder.

Moreover, the method of the invention is also characterized by the possibility of using a filling element made from a composite material.

Other features and advantages of the invention will appear in the following description.

### BRIEF SUMMARY OF THE FIGURES

In the accompanying drawings, given by way of non-limiting examples:

FIG. 1 shows a cross-sectional view of a cooking vessel according to the invention,

FIG. 2 shows a cross-sectional view of a cooking vessel according to the invention obtained by forming, embossing or stamping the layers of material of FIG. 1.

FIG. 3 is a enlarged view of the detail D of FIG. 2, and

FIGS. 4 and 5 are enlarged views of two other specific embodiments of a vessel according to the invention.

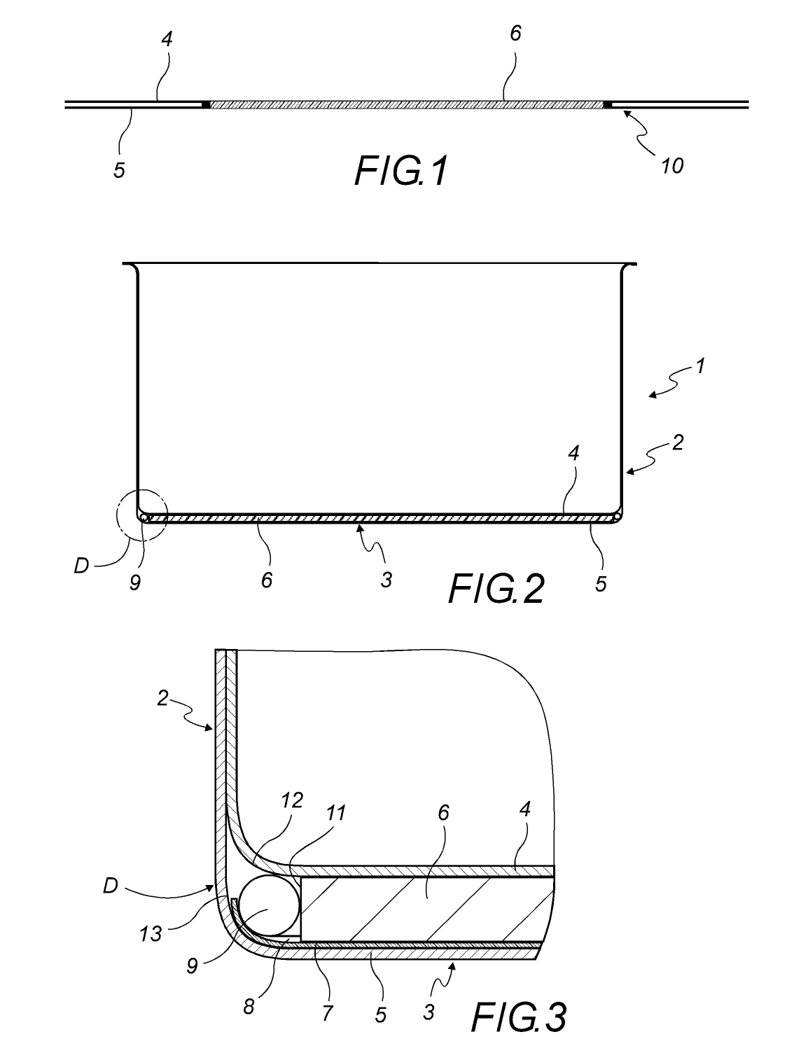

Identical elements, identified within several distinct figures, are assigned the same numeric or alphanumeric reference.

### DETAILED DESCRIPTION OF THE FIGURES

In the alternative embodiment illustrated, the cooking vessel 1 according to the invention includes a lateral wall 2 and a base 3 and is obtained by the forming, stamping or embossing of an overlap 10 of four layers of material, of different types.

The overlap 10 has a top layer 4 and a bottom layer 5 made of the same material, such as 304 18-9D type stainless steel. In the example shown, they have a thickness of 0.4 mm and a diameter of 350 mm. An intermediate layer consisting for example of Toolox 33 steel presenting, in the illustrated variant a thickness 25 of 3 mm and a diameter of 193 mm, is sandwiched and arranged in such a way as to be centered between the top layer 4 and the bottom layer 5. In the alternative embodiment illustrated, the overlap 10 also includes an additional layer 7 of a material composed of 80% nickel, with a thickness of 0.2 mm and arranged between the bottom layer 5 and the intermediate layer 6. This additional layer 7 is however optional, and does not have a special contribution to make to the present invention.

After the stamping, forming, or embossing step that allows the cooking vessel 1 to be formed, from the overlap 10 of the layers of materials, the top layer 4 and the bottom layer 5 define the lateral wall 2 of the cooking vessel 1 while the base 3 consists of the top and bottom layers 4, 5, of the intermediate layer 6 and the additional layer 7.

Referring to FIG. 3, the base 3 includes an empty space 8 delimited by the internal faces 12, 13 of the top layer 4, the bottom layer 5 and the peripheral edge 11 of the intermediate layer 6. In the example thus illustrated, the bottom layer 5 is covered by the additional layer 7 and this at the level of the base 3.

According to the invention, this empty space 8 is filled by means of a filling element 9 preferably consisting of a ductile material that can for example be introduced in solid form before the step of forming, embossing or stamping the overlap 10. In this case, said element preferably has a toroidal shape that is substantially complementary to that of the empty space 8 to be filled. The filling element 9, in sold form, can be simply and appropriately arranged between different layers of materials 4, 5, 6. It can also be assembled at the peripheral edge 11 of the intermediate layer 6, previously machined in the form of the empty space 8, for example by welding, brazing or any other equivalent assembly method.

Alternatively, the filling element 9 can be introduced during the stamping, embossing or forming step which is performed by immersing said layers of material in a bath of a filling element 9 in a liquid state, in the form of microbeads or powder

Another possible alternative additionally provides for the possibility of injecting the filling element 9 into the empty space 8 after the step of forming, embossing or stamping the cooking vessel.

According to the properties required for the base 3 of the cooking vessel 1, the filling element 9 can be designed from a material with thermal conduction properties, in particular aluminum, copper, alloys or any other material having equivalent properties.

The filling element 9 can also be designed from a material having thermal insulation qualities, that allow the thermal continuity to be broken between the different constituent layers of material of the base 3 of the cooking vessel 1. In this case, it may for example be silicon or another thermally equivalent insulation material, in particular zirconium.

Alternatively, the invention also provides for the opportunity of filling the empty space 8 by means of a filling element 9 consisting of a composite material, consisting for example of materials of different mixed or pre-agglomerate types.

Where applicable, the filling element 9 can also provide an interface between the different materials of the base 3 whose respective expansion coefficients differ from one another, thus advantageously allowing for an additional degree of freedom to be conferred to some materials and therein consequently avoiding any inadvertent distortion of the base 3.

The filling element 9 is preferably made of a different material from the intermediate layer 6, in order to present the properties of ductility, insulation or thermal conductivity, which, if necessary, the intermediate layer 6 lacks, or to allow for a mechanical discontinuity.

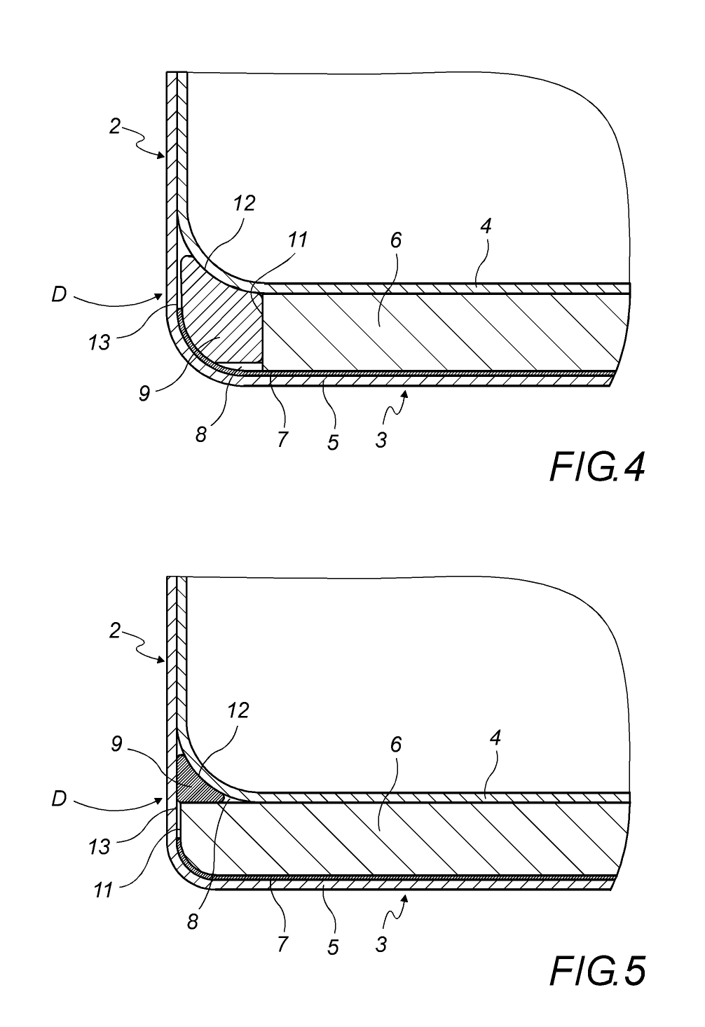

In the example embodiment illustrated in FIG. 4, the filling element 9, initially having a substantially toroidal form, is shown once it has been deformed after the operation of stamping the base 3 and lateral wall 2.

In the example embodiment illustrated in FIG. 5, an intermediate layer 6 in the form of a disc is used that is machined on its underside, in such a way as to present a rounded peripheral edge. The latter can thus be tightly enveloped by the bottom layer 5 after the stamping operation. The filling element 9 can be advantageously preformed such as to substantially present the shape of the empty space 8 located between the top layer 4 and bottom layer 5 and a top peripheral annular face of the intermediate layer 6. The filling element 9 is thus arranged and fastened to said intermediate layer 6 for example by welding or brazing. The top layer 4 and the bottom layer 5 are advantageously separately stamped beforehand and then assembled in order to enclose the filling element 9 arranged upon the intermediate layer 6. The previously stamped bottom layer 5 is for example welded prior to the intermediate layer 6 before implementing the filling element 9. The previously stamped top layer 4 is then inserted into the stamped bottom layer 5, in such a way as to fabricate the base 3 and the double lateral wall 2 of the cooking vessel thus formed.

Advantageously, by any known means, an insulating layer can be integrated between the walls forming the double lateral wall of the vessel.

The vessel according to the present invention has the remarkable advantage that the filling element 9 constitutes an interface between those materials for which the coefficient of expansion is different, thus giving an additional degree of freedom to some materials, thereby avoiding any inadvertent distortion of the base 3.

The filling element 9 may advantageously present the diameter or height of the section above the intermediate layer 6, thus ensuring optimal filling of the empty space 8 after the stamping or forming operation.

The filling element 9 can also fill part of the peripheral empty space and then sufficiently deform itself as a result of the stamping or forming operation in order to extend itself within the whole of said empty space 8.

Advantageously, the filling element 9 can be introduced directly around the intermediate layer 6 before its attachment to an internal or external chamber or else to a capsule.

In some cases, the use of a filling element 9 has the enormous advantage that it avoids an intermediate layer 6 machining operation. This is particularly advantageous when the intermediate layer is a steel disc.

In addition the filling element 9 avoids any piercing of the outer chamber or of the capsule. Such piercing is often observed when the intermediate layer 6 has a sharp edge upon which one or more outer layers are folded by means of stamping or forming.

According to an embodiment according to the invention, the bottom layer 5 can be sized in order to be welded, once stamped to the chamber formed by the top layer 4 in order to form a capsule at the base 3 of the vessel.

Of course, many changes can be made to the example described above without going beyond the scope of the invention.

1. A cooking vessel having a lateral wall connected to a base, the base comprising at least three layers of material including a top layer, a bottom layer and an intermediate layer, wherein the base comprises an space that extends around a periphery of the base and is delimited between the bottom layer, the top layer and the intermediate layer, wherein the cooking vessel further comprises a filling element positioned in the space.

2. The cooking vessel according to claim 1, wherein the filling element is at least partially made of a ductile material.

3. The cooking vessel according to claim 1, wherein the filling element is at least partially made of a thermally conductive material.

4. The cooking vessel according to claim 3, wherein the thermally conductive material is a metal selected from the group consisting of aluminum, copper, and alloys thereof.

5. The cooking vessel according to claim 1, wherein the filling element is at least partially made of a thermally insulating material.

6. The cooking vessel according to claim 5, wherein the thermally insulating material is selected from the group consisting of silicone and zirconium.

7. The cooking vessel according to claim 1, wherein the filling element comprises a composite material.

8. The cooking vessel according to claim 1, wherein the filling element has a volume that is substantially complementary to a volume of the space.

9. The cooking vessel according to claim 8, wherein the filling element has a toroidal shape.

10. A method for manufacturing the cooking vessel according to claim 1, wherein the method comprises overlapping the at least three layers of material and thereby forming the space; are positioning the filling element in the space; and forming the at least three layers of material and the filling element to form the vessel a filling element (8), an space.

11. The method according to claim 10, wherein the filling element comprises a solid form, and wherein positioning the filing element in the space comprises arranging the solid form in the space.

12. The method according to claim 11, wherein the filling element comprises a shape that is substantially complementary to the shape of the space.

13. The method according to claim 12, wherein the intermediate layer comprises a disc having a top peripheral annular face, and wherein positioning the filling element in the space comprises arranging and fastening the filling element to the top peripheral annular face of the disc.

14. The method according to claim 13, wherein overlapping the at least three layers comprises stamping the top layer and the bottom layer to form two chambers, fastening one of the two chambers to the disc, and assembling the two chambers by integrating, at least locally, an insulating layer between the two chambers.

15. The method according to claim 10, wherein the filling element comprises a liquid or a powder form, and wherein positioning the filling element in the space comprises injecting the liquid or powder form into the space after the forming.

16. The method according to claim 10, wherein the filling element comprises a liquid, microbeads, or a powder, and wherein positioning the filling element in the space comprises immersing the overlapping at least three layers of material in a bath of the liquid, microbeads, or the powder.

17. The cooking vessel according to claim 1, wherein the delimiting of the space by the intermediate layer comprises one of a peripheral edge of the intermediate layer and a top face of the intermediate layer.

18. The method according to claim 10, wherein forming comprises one of embossing and pressing.

19. The method according to claim 16, wherein immersing and forming are practiced at the same time.
